(19) United States
(12) Patent Application Publication
(10) Pub. No.: US 2011/0091268 A1
(43) Pub. Date: Apr. 21, 2011

(54) Driving Assembly with Locking Function

(76) Inventor: Bobby Hu, Taichung (TW)

(21) Appl. No.: 12/869,818

(22) Filed: Aug. 27, 2010

(30) Foreign Application Priority Data
Oct. 15, 2009 (TW) 98219054

(51) Int. Cl. F16D 1/10

(52) U.S. Cl. 403/33

(57) ABSTRACT

A driving assembly includes a body having first and second sides and an outer periphery extending between the first and second sides. A through-hole extends through the outer periphery of the body and receives a rod. A receiving groove is formed in the outer periphery and has an opening in the first side. A control groove is formed in a bottom face of the receiving groove. A driving portion extends from the first side of the body and includes a limiting groove receiving a limiting member and a positioning hole receiving a positioning member. A control member is received in the control groove and includes a control end received in the receiving groove. The control member is operable by a user to move the positioning member through transmission by the limiting member, allowing engagement with or disengaging from a workpiece.

### BACKGROUND OF THE INVENTION

The present invention relates to a driving assembly with a locking function and, more particularly, to a driving assembly that allows a user to lock or release a socket with a single hand.

FIG. 15 of U.S. Pat. No. 6,003,414 shows a quick-release socket adapter including a casing having a transverse through-hole in an end thereof. A release control rod is extended through the transverse through-hole with two ends of the release control rod extending beyond an outer periphery of the casing for manual operation by a user to control engagement or disengagement of a steel ball with or from a socket. An elongated rod is extended through the other end of the casing, allowing the user to rotate the casing.

Although engagement with or disengagement from the socket can be achieved, the ends of the release control rod extending beyond the outer periphery of the casing cause inconvenience to operation. Specifically, it is not uncommon that the fingers of the user touch oil during working, and the fingers operating the exposed ends of the release control rod are apt to slip and slide through the outer periphery of the release control rod to the outer periphery of the casing due to existence of the oil on the fingers of the user, failing to provide effective pressing.

Although the user can press the end of the release control rod by his or her palm, another inconvenience in operation occurs. This is because the user can not use a single hand to hold the casing and press an end of the release control rod by the palm. Thus, the user has to hold the casing with one hand and press an end of the release control rod with the palm of the other hand. No hands are available for the socket. Additionally, the user feels uncomfortable at the portion of the palm pressing the end of the release control rod.

Furthermore, when rotating the casing to drive a fastener by operating the elongated rod, the exposed ends of the release control rod may impinge an external object. Due to the obstacle by the object, the user has to disengage the casing from the fastener before the casing is rotated 180° and resumes the rotation after the exposed ends of the release control rod have dodged the object. Another disadvantage is that the socket may be disengaged from the casing as a result of the impingement.

Thus, a need exists for a driving assembly that allows a user to engage or disengage a socket with a single hand and that avoids inadvertent disengagement of the socket.

### BRIEF SUMMARY OF THE INVENTION

The present invention solves this need and other problems in the field of socket driving devices by providing, in a preferred form, a body including first and second sides spaced along a first axis and an outer periphery extending between the first and second sides. A through-hole extends through the outer periphery along a second axis at a non-parallel angle to the first axis. A receiving groove is formed in the outer periphery and located adjacent to the first side of the body. The receiving groove is adapted to receive a finger of a user. The receiving groove includes a bottom face. A control groove is formed in the bottom face of the receiving groove. The receiving groove has an opening in the first side of the body. A driving portion extends from the first side of the body along the first axis. The driving portion has non-circular cross sections adapted for driving a workpiece. The driving portion includes a limiting groove in communication with the control groove. The driving portion further includes a side having a positioning hole in communication with the limiting hole. A rod extends through the through-hole. The rod is slideable relative to the body along the second axis to allow adjustment of an arm of force for driving the workpiece by rotating the rod. A locking device is mounted in the body to allow the driving portion to engage with or disengage from the workpiece through operation of the locking device. The locking device includes a positioning member, a limiting member, and a control member. The positioning member is slideably received in the positioning hole. The limiting member is received in the limiting groove and slideable along the first axis between a release position and an engagement position. The positioning member is in a locking position partially protruding out of the positioning hole to retain the workpiece on the driving portion when the limiting member is in the engagement position. The positioning member is in an unlocking position received in the positioning hole when the limiting member is in the release position, allowing removal of the workpiece from the driving portion. The control member is received in the control groove and movable between an operative position corresponding to the engagement position of the limiting member and a disengagement position corresponding to the release position of the limiting member. The control member is operatively connected to the limiting member to move the limiting member between the release position and the engagement position. The control member is biased to the operative position. The control member is operable by the user to move between the operative position and the disengagement position for moving the positioning member between the locking position and the unlocking position.

In the most preferred form, the second axis is perpendicular to the first axis. The control groove extends along a third axis perpendicular to the first and second axes. The third axis intersects the first axis but does not intersect the second axis. The control groove is spaced from the through-hole to prevent the rod from interfering with movement of the control member between the operative position and the disengagement position along the third axis. The control member includes a control end extending out of the control groove beyond the bottom face of the receiving groove. The control end is received in the receiving groove and does not extend beyond the outer periphery of the body. The bottom face of the receiving groove has first, second, and third edges at an interconnection area with the outer periphery of the body. The first edge has a spacing to the second side of the body larger than the second and third edges. Each of the second and third edges extends from one of two ends of the first edge to the first side of the body. A first spacing is defined between the outer periphery of the body and the first axis in a radial direction perpendicular to the first axis. The control groove has an open end in the bottom face of the receiving groove. A second spacing is defined between the opening of the control groove and the first axis and closest to the first axis. The second spacing is smaller than the first spacing. Each of the second and third edges of the receiving groove has a projection line perpendicular to the third axis. The projection line intersects the third axis at an intersection. A third spacing is defined between the intersection and the first axis in a direction perpendicular to the first axis. The third spacing is smaller than the first spacing but larger than the second spacing. The control end of the control member is movable within a movable distance in a radial direction perpendicular to the first axis when the control member moves between the operative position and the disengagement position. The movable distance of the control end of the control member is not larger than the first spacing. The movable distance of the control end of the control member is not smaller than the second spacing such that the control end is not located in the control groove when the control member is in the disengagement position. A first width is defined between the second edge of the receiving groove and the third axis in a direction perpendicular to the third axis. A second width is defined between the third edge of the receiving groove and the third axis in a direction perpendicular to the third axis. A third width is defined between the first edge of the receiving groove and the third axis in a direction perpendicular to the third axis. The first thickness is equal to the second thickness, and the third thickness is larger than the first thickness, allowing easy entrance of the finger of the user into the receiving groove via the first edge and allowing the user to operate the control member without interference.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a driving assembly according to the preferred teachings of the present invention.

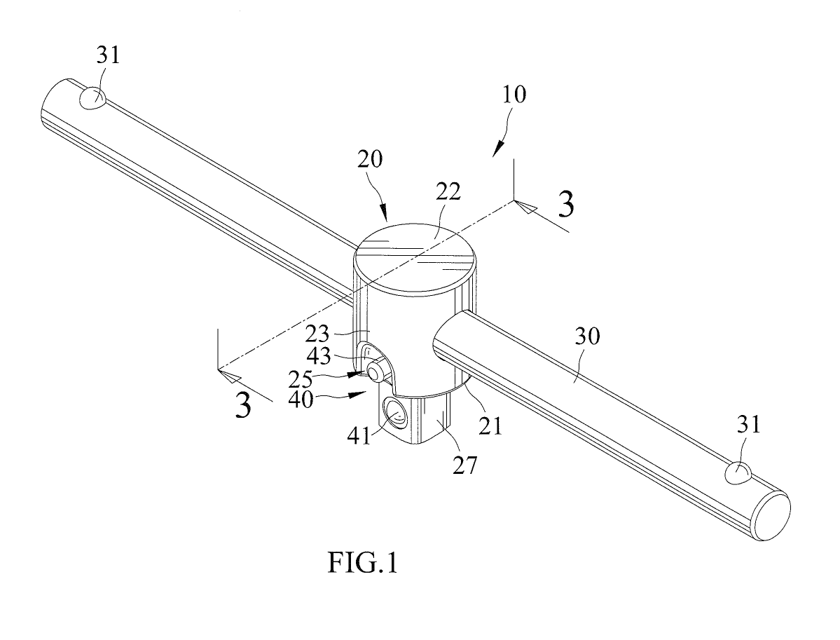

FIG. 2 shows an exploded, perspective view of the driving assembly of FIG. 1.

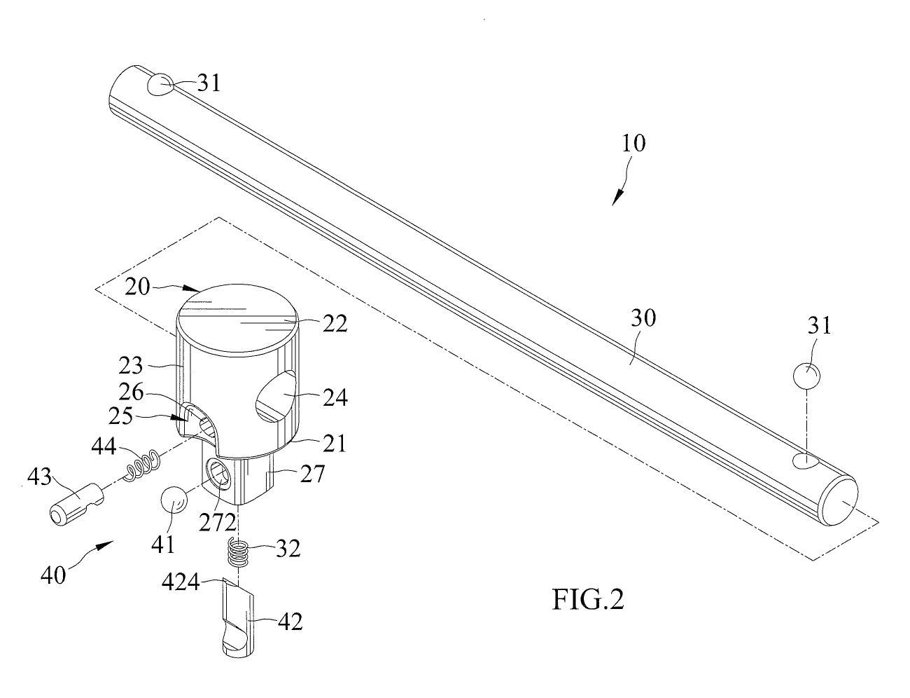

FIG. 3 shows a cross sectional view of the driving assembly of FIG. 1 according to section line 3-3 of FIG. 1.

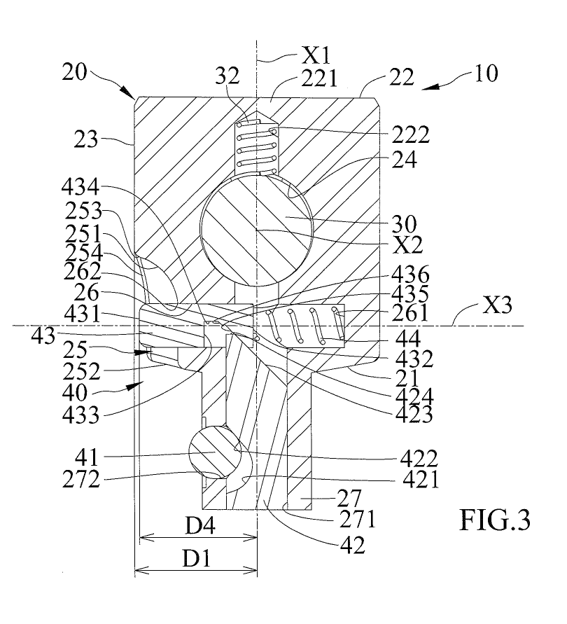

FIG. 4 shows a partial, side view of the driving assembly of FIG. 1.

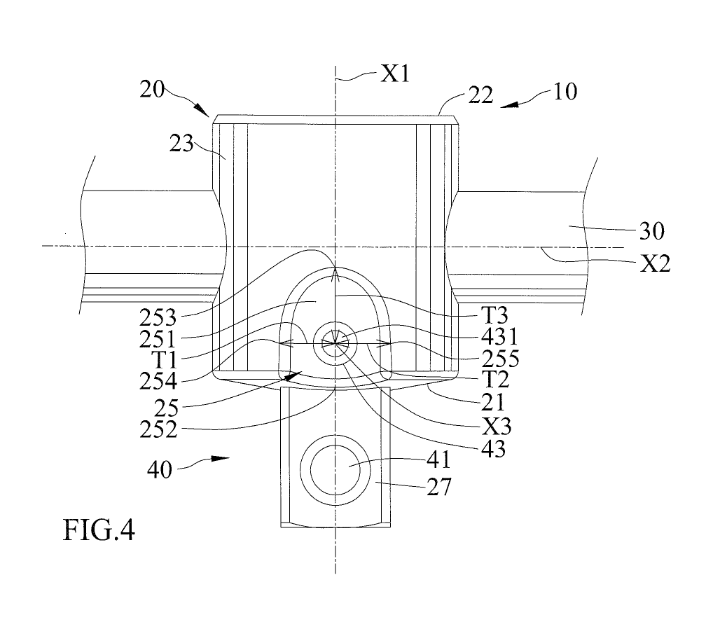

FIG. 5 shows a partial, bottom view of the driving assembly of FIG. 1.

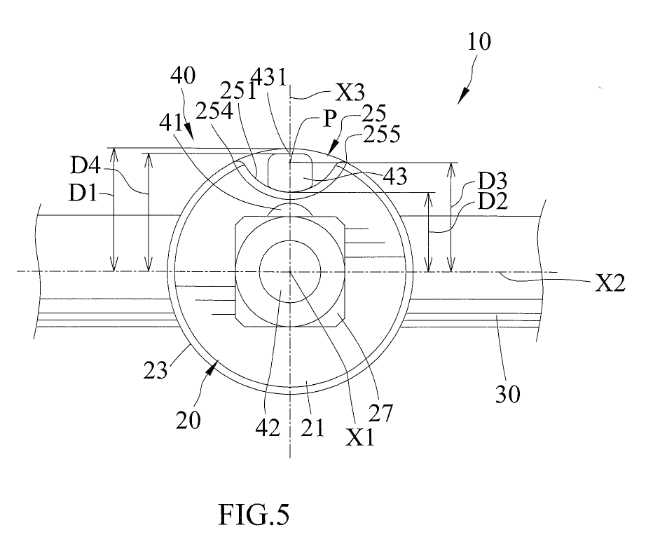

FIG. 6 shows a cross sectional view of the driving assembly of FIG. 1 engaged with a socket with a control member pressed.

FIG. 7 shows a cross sectional view similar to FIG. 6, illustrating removal of the socket.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “lower”, “upper”, “inner”, “outer”, “side”, “end”, “portion”, “section”, “longitudinal”, “axial”, “radial”, “circumferential”, “centrifugal”, “lateral”, “horizontal”, “vertical”, “annular”, “outward”, “inward”, “spacing”, “clockwise”, “counterclockwise”, “length”, “width”, “height”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A driving assembly according to the preferred teachings of the present invention is shown in the drawings and generally designated 10. According to the preferred form shown, driving assembly 10 includes a body 20, a rod 30 extending through body 20, and a locking device 40 mounted to an end of body 20.

According to the preferred form shown, body 20 includes first and second sides 21 and 22 spaced along a first axis X1 and an outer periphery 23 extending between first and second sides 21 and 22. Body 10 generally has circular cross sections. A first spacing D1 is defined between outer periphery 23 of body 20 and first axis X1 in a radial direction perpendicular to first axis X1. First spacing D1 is equal to the maximum radius of outer periphery 23 of body 20.

According to the preferred form shown, a through-hole 24 extends through outer periphery 23 along a second axis X2 at a non-parallel angle to first axis X1. In the most preferred form shown, second axis X2 is perpendicular to and intersects first axis X1. A receiving groove 25 is formed in outer periphery 23 and located adjacent to first side 21 of body 20. Receiving groove 25 is adapted to receive a finger of a user, allowing the user to operate lock device 40 with a single hand. Receiving groove 25 includes a bottom face 251 for contact with the finger that moves in receiving groove 25 while pressing locking device 40. In the most preferred form shown, receiving groove 25 has an opening 252 in first side 21 of body 20. Opening 252 permits the finger of the user to move out of receiving compartment 25 via first side 21 of body 21, increasing the movable space for the finger after entering receiving groove 25.

In the most preferred form shown, bottom face 251 of receiving groove 25 has first, second, and third edges 253, 254, and 255 at an interconnection area with outer periphery 23 of body 20. First edge 253 includes a spacing to second side 22 of body 20 larger than second and third edges 254 and 255. Each of second and third edges 254 and 255 extends from one of two ends of first edge 253 to first side 21 of body 20. Namely, each of second and third edges 254 and 255 extends between first edge 253 and opening 252. A first width T1 is defined between second edge 254 of receiving groove 25 and third axis X3 in a direction perpendicular to third axis X3. A second width T2 is defined between third edge 255 of receiving groove 25 and third axis X3 in a direction perpendicular to third axis X3. A third width T3 is defined between first edge 253 of receiving groove 25 and third axis X3 in a direction perpendicular to third axis X3. First thickness T1 is equal to second thickness T2, and third thickness T3 is larger than first thickness T1, allowing easy entrance of the finger of the user into receiving groove 25 via first edge 253 and allowing the user to operate locking device 4 without interference by first edge 253.

According to the preferred form shown, a control groove 26 is formed in bottom face 251 of receiving groove 25. Control groove 26 extends along a third axis X3 that is perpendicular to and that intersects first axis X1. In the most preferred form shown, third axis X3 is perpendicular to but does not intersect second axis X2. Control groove 26 includes a closed end 261 in body 20 and an open end 262 in bottom face 251 of receiving groove 25. A second spacing D2 is defined between opening 262 of control groove 26 and first axis X1 and closest to first axis X1. Second spacing D2 is smaller than first spacing D1. Each of second and third edges 254 and 255 of receiving groove 25 has a projection line perpendicular to third axis X3. The projection line intersects third axis X3 at an intersection P. A third spacing D3 is defined between intersection P and first axis X1 in a direction perpendicular to first axis X. Third spacing D3 is smaller than first spacing D1 but larger than second spacing D2. Thus, bottom face 251 of receiving groove 25 is concave and arcuate for snugly receiving the finger of the user while allowing easy pressing of locking device 40.

According to the preferred form shown, a driving portion 27 extends from first side 21 of body 20 along first axis X1. Driving portion 27 has non-circular cross sections adapted for driving a workpiece 90 such as a socket. In the most preferred form shown, driving portion 27 has square cross sections for engaging with a square hole of a socket. Driving portion 27 includes a limiting groove 271 extending along first axis X1 and having circular cross sections. Limiting groove 271 extends through driving portion 27 and is in communication with control groove 26. Driving portion 27 further includes a side having a positioning hole 272 in communication with limiting hole 271. In the most preferred form shown, positioning hole 272 extends in a radial direction perpendicular to first axis X1.

According to the preferred form shown, second side 22 of body 20 has an end wall 221. A receptacle 222 is formed between through-hole 24 and end wall 221 and in communication with through-hole 24. Through-hole 24 is intermediate receptacle 222 and control groove 26 along first axis X1.

According to the preferred form shown, rod 30 includes circular cross sections and extends through through-hole 24. Rod 30 is slideable relative to body 20 along second axis X2 to allow adjustment of an arm of force for driving workpiece 90 by rotating rod 30. Body 20 can be rotated about first axis X1 by rotating rod 30. Rod 30 includes two ends each having a hole. A retaining member 31 mounted in each of the holes of rod 30 and can be biased by a spring mounted in each hole to a protruded position. Retaining member 31 can be in the form of a steel ball and prevents rod 30 from disengaging from body 20 by abutting outer periphery 23 of body 20.

An elastic element 32 is mounted in receptacle 222 and between end wall 221 and rod 30. Elastic element 32 biases an outer periphery of rod 30 to press against an inner periphery of through-hole 24, preventing undesired rotation and sliding between rod 30 and body 20 by friction therebetween.

According to the preferred form shown, locking device 40 is mounted in body 20 to allow driving portion 27 to engage with or disengage from workpiece 90 through operation of locking device 40. Locking device 40 includes a positioning member 41, a limiting member 42, and a control member 43. Positioning member 41 is received in the positioning hole 272 and slideable along the radial direction between a locking position partially protruding out of the positioning hole 272 and an unlocking position received in positioning hole 272. Limiting member 42 is received in limiting groove 271 and slideable along first axis X1 between a release position and an engagement position. Positioning member 41 is in the locking position engaged in a ball groove 91 of workpiece 90 to retain the workpiece 90 on driving portion 27 when limiting member 42 is in the engagement position. Positioning member 41 is in the unlocking position when limiting member 42 is in the release position, allowing removal of workpiece 90 from driving portion 27. Limiting member 42 includes a cavity 421 and an inclined positioning face 422 contiguous to cavity 421. Cavity 421 receives positioning member 41 in the unlocking position such that positioning member 41 does not extend beyond positioning hole 272. Inclined positioning face 422 presses against positioning member 41 in the locking position such that positioning member 41 partially protrudes out of positioning hole 272 when positioning member 41 is in the locking position. An inner end of limiting member 42 extends into receiving groove 25 and includes an inclined follower face 423 and a distal end portion 424.

According to the preferred form shown, control member 43 is received in control groove 26 and movable between an operative position corresponding to the engagement position of limiting member 42 and a disengagement position corresponding to the release position of limiting member 42. Control member 43 is operatively connected to limiting member 42 to move limiting member 42 between the release position and the engagement position. Control member 43 is operable by the user to move between the operative position and the disengagement position for moving positioning member 41 between the locking position and the unlocking position. Since control member 43 is received in control groove 26 that is spaced from through-hole 24 receiving rod 30, movement of control member 43 between the operative position and the disengagement position along third axis X3 will not be interfered by rod 30.

According to the preferred form shown, control member 43 includes a control end 431 extending out of control groove 26 beyond bottom face 251 of receiving groove 25. Control end 431 is received in receiving groove 25 and does not extend beyond outer periphery 23 of body 20. Control end 431 of control member 43 is movable within a movable distance D4 in a radial direction perpendicular to first axis X1 when control member 43 moves between the operative position and the disengagement position. Movable distance D4 of control end 431 of control member 43 is not larger than first spacing D1. Namely, control end 431 of control member 43 remains in receiving groove 25 and will not protrude outside of outer periphery 23 of body 20. Thus, control member 43 will not be impinged by external objects during rotation of body 20. In the most preferred form shown, movable distance D4 of control end 431 of control member 43 is not smaller than second spacing D2 such that control end 431 is not located in control groove 26 when control member 43 is in the disengagement position. Thus, the user does not have to push control end 431 into control groove 26, allowing simple and comfortable operation. These advantages can be achieved by maintaining movable distance D4 of control end 431 of control member 43 in the extent of third spacing D3.

According to the preferred form shown, control member 43 further includes an abutting end 432 received in control groove 26. An elastic element 44 is mounted between closed end 261 of control groove 26 and abutting end 432 of control member 43. Elastic element 44 biases control member 43 from the disengagement position to the operative position. Control member 43 further includes a control recess 433 receiving inclined follower face 423 and distal end portion 424 of limiting member 42. Control recess 433 includes an inclined control face 435 and a stop face 434. Inclined control face 435 of control recess 433 is in sliding contact with inclined follower face 423 of limiting member 42 such that limiting member 42 slides along first axis X1 while control member 43 slides along third axis X3. Movement of limiting member 42 towards control member 43 is stopped when distal end portion 424 of limiting member 42 abuts against the stop face 434 of control member 43. Control member 43 further includes a safety protrusion 436 formed between inclined control face 435 and stop face 434 of control recess 433. Safety protrusion 436 abuts against distal end portion 424 of limiting member 42 when positing member 41 is in the locking position, preventing positioning member 41 from being moved to the unlocking position by an external force and preventing movement of limiting member 42 from the engagement position to the release position. Reliable engagement between positioning member 41 and ball groove 91 of workpiece 90 is, thus, obtained.

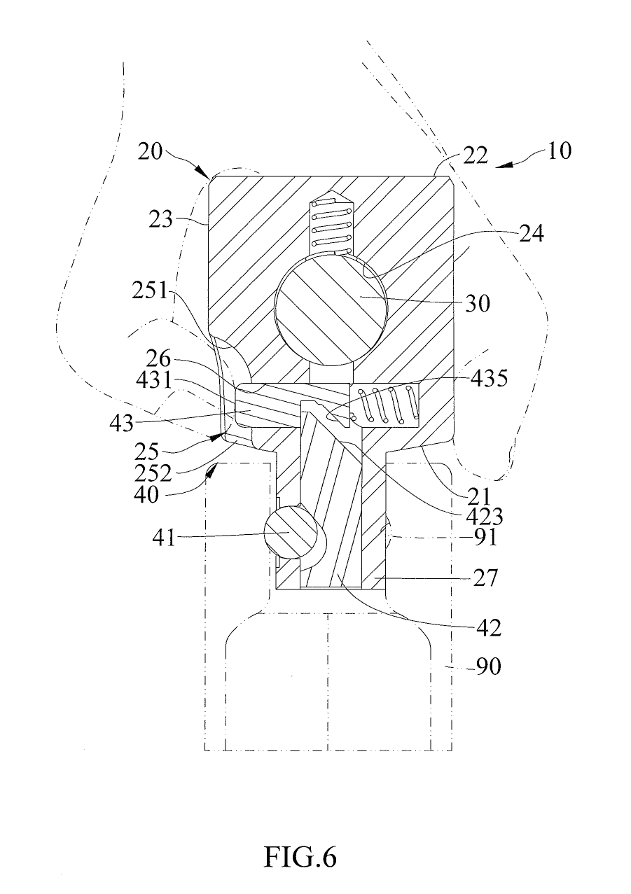

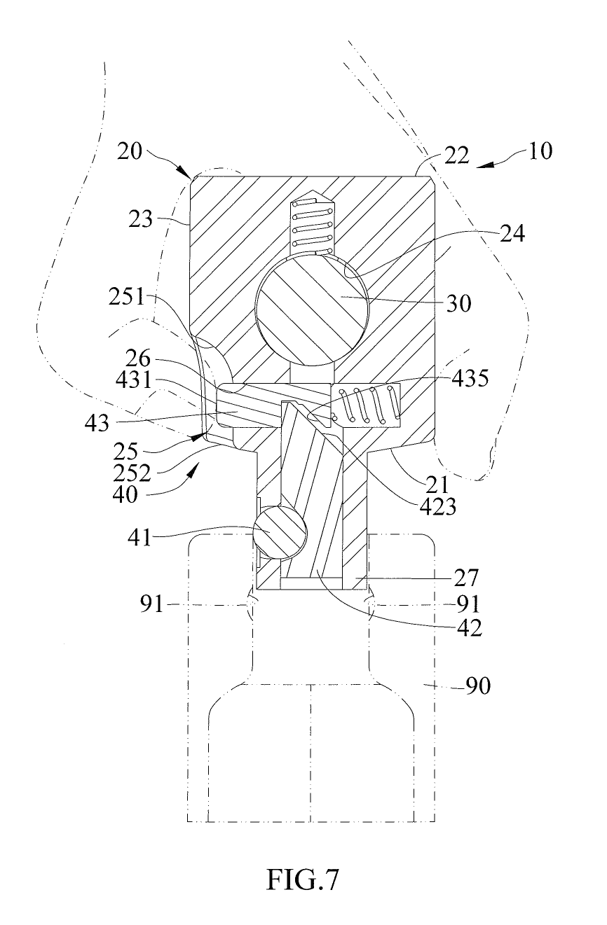

With reference to FIGS. 6 and 7, when it is desired to remove workpiece 90 from driving portion 27, the user inserts his or her finger into receiving groove 25 of body 20 and presses control end 431 to move control member 43 towards end wall 261 of control groove 26. It can be appreciated that the pressing operation can be easily achieved with a single hand. When the inclined follower face 423 of limiting member 42 is not pressed against by inclined control face 435 of control member 43, limiting member 42 and positioning member 41 are in a released state. Workpiece 90 can be removed from driving portion 27 by the free hand of the user, providing convenient use and avoiding failure in pressing control end 431 of control member 43.

Since movable distance D4 of control end 431 of control member 43 is not larger than first spacing D1 and not smaller than second spacing D2, control end 431 will not enter control groove 26 while pressing control member 43, providing simple and comfortable operation. Furthermore, control end 431 of control member 43 remains in receiving groove 25 and does not extend beyond outer periphery 23 of body 20, avoiding the risk of undesired impingement by external objects and allowing continuous rotating of body 20. Further, opening 252 of receiving groove 25 allows the finger of the user to easily move out of receiving groove 25 after operation and allows operation by users having different finger lengths. Further, when it is desired to remove workpiece 90 from driving portion 27, the user can press control member 43 with a finger and then move the finger towards opening 252 to push workpiece 90, allowing easy disengagement of workpiece 90.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A driving assembly comprising, in combination:
a body including first and second sides spaced along a first axis and an outer periphery extending between the first and second sides, with a through-hole extending through the outer periphery along a second axis at a non-parallel angle to the first axis, with a receiving groove formed in the outer periphery and located adjacent to the first side of the body, with the receiving groove adapted to receive a finger of a user, with the receiving groove including a bottom face, with a control groove formed in the bottom face of the receiving groove, with the receiving groove having an opening in the first side of the body, with a driving portion extending from the first side of the body along the first axis, with the driving portion having non-circular cross sections adapted for driving a workpiece, with the driving portion including a limiting groove in communication with the control groove, with the driving portion further including a side having a positioning hole in communication with the limiting hole;
a rod extending through the through-hole, with the rod slideable relative to the body along the second axis;
a locking device mounted in the body to allow the driving portion to engage with or disengage from the workpiece through operation of the locking device, with the locking device including a positioning member, a limiting member, and a control member, with the positioning member slideably received in the positioning hole, with the limiting member received in the limiting groove and slideable along the first axis between a release position and an engagement position, with the positioning member being in a locking position partially protruding out of the positioning hole to retain the workpiece on the driving portion when the limiting member is in the engagement position, with the positioning member being in an unlocking position received in the positioning hole when the limiting member is in the release position, allowing removal of the workpiece from the driving portion, with the control member received in the control groove and movable between an operative position corresponding to the engagement position of the limiting member and a disengagement position corresponding to the release position of the limiting member, with the control member operatively connected to the limiting member to move the limiting member between the release position and the engagement position, with the control member biased to the operative position, with the control member operable by the user to move between the operative position and the disengagement position for moving the positioning member between the locking position and the unlocking position.

2. The driving assembly as claimed in claim 1, with the control groove extending along a third axis perpendicular to the first and second axes, with the control member slideable along the third axis between the operative position and the disengagement position, with the bottom face of the receiving groove having first, second, and third edges at an interconnection area with the outer periphery of the body, with the first edge including two ends and having a spacing to the second side of the body larger than the second and third edges, with each of the second and third edges extending from one of the two ends of the first edge to the first side of the body, with a first spacing defined between the outer periphery of the body and the first axis in a radial direction perpendicular to the first axis, with the control groove having an open end in the bottom face of the receiving groove, with a second spacing defined between the opening of the control groove and the first axis and closest to the first axis, with each of the second and third edges of the receiving groove having a projection line perpendicular to the third axis, with the projection line intersecting the third axis at an intersection, with a third spacing defined between the intersection and the first axis in a direction perpendicular to the first axis, with the third spacing smaller than the first spacing but larger than the second spacing, with the bottom face of the receiving groove being concave and arcuate.

3. The driving assembly as claimed in claim 2, with a first width defined between the second edge of the receiving groove and the third axis in a direction perpendicular to the third axis, with a second width defined between the third edge of the receiving groove and the third axis in a direction perpendicular to the third axis, with a third width defined between the first edge of the receiving groove and the third axis in a direction perpendicular to the third axis, with the first thickness equal to the second thickness, with the third thickness larger than the first thickness, allowing easy entrance of the finger of the user into the receiving groove via the first edge and allowing the user to operate the control member without interference.

4. The driving assembly as claimed in claim 2, with the control member including a control end extending out of the control groove beyond the bottom face of the receiving groove, with the control end received in the receiving groove and not extending beyond the outer periphery of the body.

5. The driving assembly as claimed in claim 4, with the first spacing equal to a maximum radius of the outer periphery of the body, with the control end of the control member movable within a movable distance in a radial direction perpendicular to the first axis when the control member moves between the operative position and the disengagement position, with the movable distance of the control end of the control member not larger than the first spacing.

6. The driving assembly as claimed in claim 5, with the second spacing smaller than the first spacing, with the movable distance of the control end of the control member not smaller than the second spacing such that the control end is not located in the control groove when the control member is in the disengagement position.

7. The driving assembly as claimed in claim 6, with the second axis extending perpendicularly to and intersecting the first axis, with the body rotatable about the first axis by rotating the rod, with the third axis not intersecting the second axis, with the control groove spaced from the through-hole, preventing the rod from interfering with movement of the control member between the operative position and the disengagement position along the third axis.

8. The driving assembly as claimed in claim 7, with the control groove further including a closed end in the body, with the control member further including an abutting end received in the control groove, with the driving assembly further comprising, in combination: an elastic element mounted between the closed end of the control groove and the abutting end of the control member, with the elastic element biasing the control member from the disengagement position to the operative position.

9. The driving assembly as claimed in claim 8, with the limiting member including an inner end extending into the receiving groove, with the inner end of the limiting member including an inclined follower face and a distal end portion, with the control member including a control recess receiving the inclined follower face and the distal end portion of the limiting member, with the control recess including an inclined control face and a stop face, with the inclined control face of the control recess in sliding contact with the inclined follower face of the limiting member such that the limiting member slides along the first axis while the control member slides along the third axis, with movement of the limiting member towards the control member being stopped when the distal end portion of the limiting member abuts against the stop face of the control member.

10. The driving assembly as claimed in claim 9, with the control member further including a safety protrusion formed between the inclined control face and the stop face of the control recess, with the safety protrusion abutting against the distal end portion of the limiting member when the positing member is in the locking position, preventing movement of the limiting member from the engagement position to the release position.

11. The driving assembly as claimed in claim 10, with the positioning member movable between the locking position and the unlocking position in the positioning hole in a radial direction perpendicular to the first axis, with the limiting member including a cavity and an inclined positioning face contiguous to the cavity, with the cavity receiving the positioning member when the positioning member is in the unlocking position such that the positioning member does not extend beyond the positioning hole, with the inclined positioning face pressing against the positioning member such that the positioning member partially protrudes out of the positioning hole when the positioning member is in the locking position.

12. The driving assembly as claimed in claim 11, with the second side of the body including an end wall, with the body further including a receptacle between the through-hole and the end wall and in communication with the through-hole, with the through-hole intermediate the receptacle and the control groove along the first axis, with another elastic member received in the receptacle and mounted between the end wall of the body and the rod, with the rod including two ends, with a retaining member mounted to each of the two ends of the rod, with the retaining member preventing the rod from disengaging from the body by abutting the outer periphery of the body.
